(19) United States
(12) Patent Application Publication
(10) Pub. No.: US 2025/0303828 A1
(43) Pub. Date: Oct. 2, 2025

(54) Register Device for Vehicle

(71) Applicants: SHIGERU CO., LTD., Ota-shi (JP); SUBARU CORPORATION, Tokyo (JP)

(72) Inventors: Kazuaki Hoshi, Ota-shi (JP); Takahiro Makizono, Tokyo (JP); Hiroshi Nakamura, Tokyo (JP)

(21) Appl. No.: 19/087,989

(22) Filed: Mar. 24, 2025

(30) Foreign Application Priority Data
Mar. 29, 2024 (JP) 2024-055969

(51) Int. Cl. B60H 1/34

(52) U.S. Cl. CPC B60H 1/3421

(57) ABSTRACT

A register device includes a register body and fins. The register body includes peripheral walls and an inner portion surrounded by the peripheral walls. The fins are rotatably disposed in the inner portion surrounded by the peripheral walls. The inner portion serves as an air passage. The fins open and close the air passage. Raised surfaces are formed in an upper wall and a lower wall. The raised surfaces are abutted against extended portions of the fins when the fins are in a closing state. Saw-toothed notches are formed in edge portions of the raised surfaces on a side of a central axis of the air passage.

### CROSS-REFERENCE TO RELATED APPLICATIONS

The present application claims priority from Japanese Patent Application No. 2024-055969 filed on Mar. 29, 2024, the entire contents of which are hereby incorporated by reference.

### BACKGROUND

The present disclosure relates to a register device for a vehicle including opening and closing plate portions that open and close an air passage.

A common register device mounted in an instrument panel of a vehicle or the like includes a register body having an air passage, a blow outlet side fin assembly disposed on a blow outlet side of the air passage and an upstream side fin assembly disposed on an upstream side of the air passage. One of the blow outlet side fin assembly and the upstream side fin assembly includes a plurality of fins extending in a left-right direction and disposed spaced from one another in a vertical direction. A blow out direction can be adjusted in the vertical direction by adjusting tilt of these fins. The other of the fin assemblies includes a plurality of fins extending in the vertical direction and disposed spaced from one another in the left-right direction. The blow out direction can be adjusted in the left-right direction by adjusting tilt of these fins.

In the register device mentioned above, the air passage can be opened and closed off by operation of a driver or a passenger, thereby selectively stopping air flow. Among such register devices is a register device disclosed in the Unexamined Japanese Patent Application Publication No. 2018-144551 mentioned below that includes a fin assembly with a function to close off an air passage.

In the register device disclosed in the Japanese Unexamined Patent Application Publication No. 2018-144551, when fins are tilted to a maximum extent, the fins are contacted with one another overlapping one another. At the same time, edge portions of the fins are abutted against raised surfaces disposed inside peripheral walls of a register body, thereby closing off an air passage.

### SUMMARY

One embodiment of the present disclosure provides a register device for a vehicle. The register device for the vehicle includes a register body and an opening and closing plate portion. The register body includes peripheral walls and an inner portion surrounded by the peripheral walls. The inner portion serves as an air passage. The opening and closing plate portion is rotatably disposed in the inner portion surrounded by the peripheral walls. The opening and closing plate portion opens and closes the air passage.

A raised surface is formed in the peripheral walls. The raised surface is abutted against an edge portion of the opening and closing plate portion when the opening and closing plate portion is in a closing state.

Saw-toothed notches are formed in an edge portion of the raised surface on a side of a central axis of the air passage.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a perspective view of a register device according to one embodiment of the present disclosure.

FIG. 2 is a perspective cross-sectional view taken along line II-II of FIG. 1, showing the register device in a normal state of blowing.

FIG. 3 is a perspective cross-sectional view taken along line II-II of FIG. 1, showing the register device in a state in which an air passage is closed off and the air flow is stopped.

FIG. 4 is a perspective cross-sectional view taken along line IV-IV of FIG. 1, showing the register device in the state in which the air passage is closed off and the air flow is stopped.

FIG. 5 is a perspective view, showing an inside of the register device, with an operation knob, an engagement member engaging the operation knob and upstream side fins with one another and the upstream side fins on a left side omitted.

FIG. 6 is an enlarged perspective view of a main portion of the inside of the register device.

FIG. 7 is a cross-sectional view taken along line VII-VII of FIG. 6.

### DETAILED DESCRIPTION

Velocity of air flowing in an air passage of a register device at a high velocity is relatively reduced near surfaces of peripheral walls due to viscosity. This may facilitate formation of large vortexes on a downstream side. In the register device disclosed in the Japanese Unexamined Patent Application Publication No. 2018-144551, large vortexes may be separated from surfaces of the peripheral walls when the air passes through the raised surfaces, generating rapid pressure changes, thereby generating abnormal noises. Therefore, it is desired to provide a register device for a vehicle that solves the problems mentioned above.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

One embodiment of the present disclosure is described hereinafter with reference to the drawings. In the following description, front-rear and left-right directions are determined in accordance with front-rear and left-right directions of a vehicle.

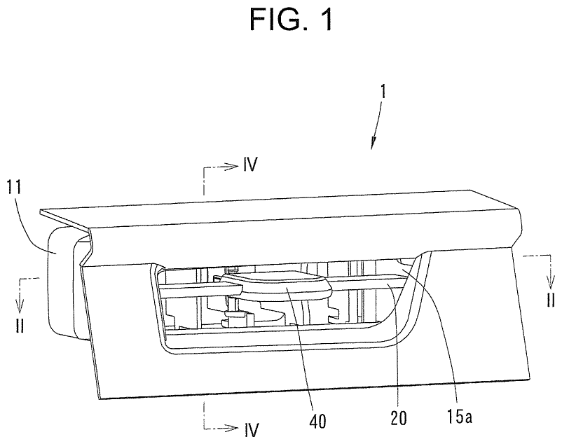

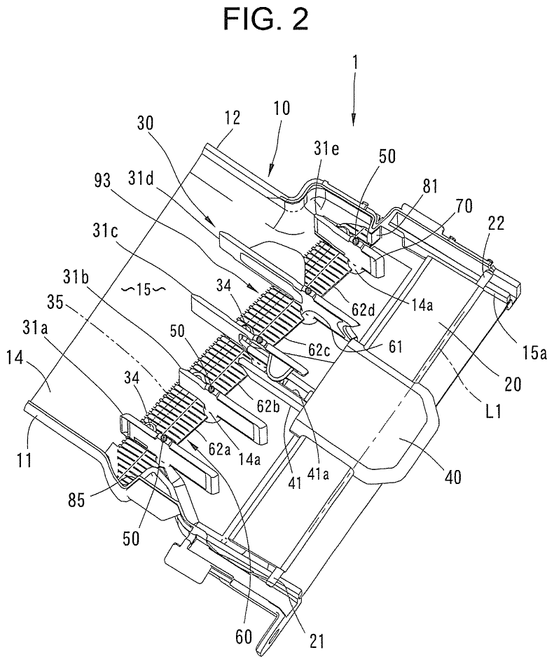

The register device 1 shown in FIG. 1 is disposed in an instrument panel (not shown) of a vehicle. As shown in FIGS. 2 to 4, the register device 1 includes a register body 10. An upstream end of the register body 10 is connected to an air conditioning device (not shown) via a duct.

The register body 10 has a cylindrical configuration having a generally rectangular cross-section. The register body 10 extends in the front-rear direction (longitudinal direction) of the vehicle. The register body 10 includes a left side wall 11, a right side wall 12, an upper wall 13 and a lower wall 14 as peripheral walls. An inner space of the register body 10 is provided as an air passage 15. A downstream end of the air passage 15 serves as a blow outlet 15a to an interior of the vehicle.

A blow outlet side fin 20 and an upstream side fin assembly 30 are disposed in the air passage 15 of the register body 10. The blow outlet side fin 20 is disposed near the blow outlet 15a. The upstream side fin assembly 30 is spaced from the blow outlet 15a and disposed on back side, i.e., the upstream side with respect to the blow outlet side fin 20.

The blow outlet side fin 20 has an elongated plate configuration extending in the left-right direction. The blow outlet side fin 20 has rotation shafts 21, 22 at left and right ends thereof. The rotation shafts 21, 22 are inserted in bearing holes (not shown) formed in the left side wall 11 and the right side wall 12 of the register body 10, thereby supporting the blow outlet side fin 20 such that the blow outlet side fin 20 is rotatable about a rotation axis L1 (shown in FIG. 2 only) extending in the left-right direction.

An operation knob 40 is mounted on the blow outlet side fin 20. By grasping and moving the operation knob 40, the blow outlet side fin 20 can be rotated about the rotation axis L1, thereby vertically adjusting a blow out direction of the blow outlet side fin 20.

The upstream side fin assembly 30 includes a plurality of, five, for example, fins (opening and closing plate portions) 31a, 31b, 31c, 31d, 31e and an interlocking link 35 (shown in FIG. 2 only in imaginary lines) that rotatably connects the fins 31a, 31b, 31c, 31d, 31e.

The plurality of fins 31a, 31b, 31c, 31d, 31e having elongated plate configurations are oriented with short direction thereof in the vertical direction and disposed spaced from one another in the left-right direction.

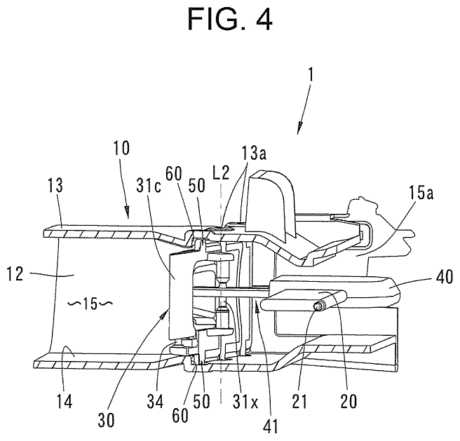

Rotation shafts 50 at upper ends and lower ends of the plurality of fins 31a, 31b, 31c, 31d, 31e are respectively rotatably supported in bearing holes 13a, 14a respectively formed in the upper wall 13 and the lower wall 14. Of the fins 31a, 31b, 31c, 31d, 31e, a rotation axis of the fin 31c is denoted with reference numeral L2 in FIG. 4.

The interlocking link 35 shown in FIG. 2 extends in the left-right direction. Connecting shafts 34 of the plurality of fins 31a, 31b, 31c, 31d, 31e are rotatably connected to the interlocking link 35. The connecting shafts 34 extend parallel to the rotation shafts 50 and are disposed on the upstream side (back side) with respect to the rotation shafts 50. Via the interlocking link 35, the plurality of fins 31a, 31b, 31c, 31d, 31e are coordinated in motion.

The operation knob 40 is supported by the blow outlet side fin 20 so as to be slidable in the left-right direction. An engagement member 41 protruded toward upstream side is supported by the operation knob 40 so as to be vertically swingable. A slit 41a is formed in the engagement member 41. The fin 31c at a center (central fin) of the upstream side fin assembly 30 has a pin 31x as shown in FIG. 4. The pin 31x is disposed in the slit 41a of the engagement member 41. The pin 31x is disposed on the downstream side with respect to the rotation shafts 50 and extends parallel to the rotation shafts 50. The central fin 31c has a cutout adjacent to the pin 31x, thereby avoiding interference between the engagement member 41 and the fin 31c.

When the operation knob 40 is slid in the left-right direction along the blow outlet side fin 20, the central fin 31c is rotated about the rotation axil L2, and the other fins 31a, 31b, 31d, 31e are concurrently rotated via the interlocking link 35 (FIG. 2). Thereby, the blow out direction can be adjusted in the left-right direction by the upstream side fin assembly 30.

A structure for closing off the air passage 15 by the upstream side fin assembly 30 will be described hereinafter.

As shown in FIG. 4, on the upstream side of the upstream side fin assembly 30, inner surfaces of the upper wall 13 and the lower wall 14 are inclined toward a central axis of the air passage 15 from the upstream side toward the downstream side. Then, the inner surfaces of the upper wall 13 and the lower wall 14 extend respectively upward and downward. Accordingly, the inner surfaces of the upper wall 13 and the lower wall 14 on the upstream side are raised from the downstream side toward the air passage 15, thereby forming raised surfaces 60 oriented to the blow outlet 15a side.

As shown in FIGS. 2, 4 and 6, each of the raised surfaces 60 extends in the left-right direction. Each of the raised surfaces 60 includes recessed curved surfaces 61 for receiving the rotation shafts 50 of the fins 31a, 31b, 31c, 31d, 31e. Each of the raised surfaces 60 also includes limiting surfaces (raised surfaces) 62a, 62b, 62c, 62d, 62e each extending rightward from the recessed curved surfaces 61.

In the drawings, only the recessed curved surface 61 and the limiting surfaces 62a, 62b, 62c, 62d, 62e of the raised surface 60 of the lower wall 14 are shown. Although not shown, similar recessed curved surface 61 and limiting surfaces 62a, 62b, 62c, 62d, 62e are formed in the raised surface 60 of the upper wall 13.

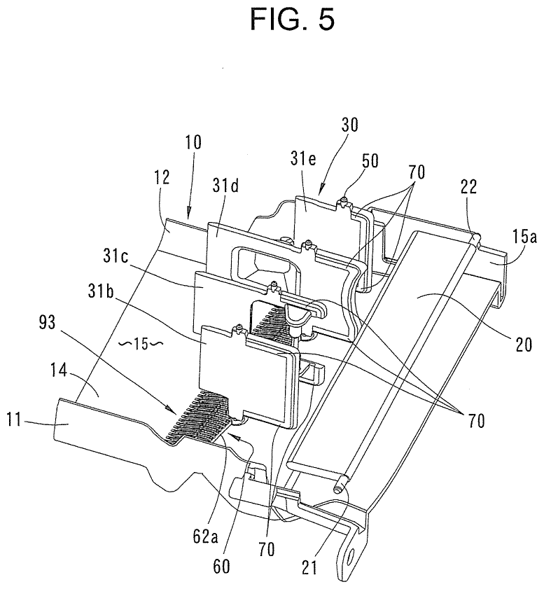

As shown in FIGS. 2 and 5, the fins 31a, 31b, 31c, 31d, 31e of the upstream side fin assembly 30 have extended portions (edge portions) 70 formed in the upper ends and the lower ends thereof on the downstream side. The extended portions 70 formed in the upper ends and the lower ends of the fins are respectively protruded towards the upper wall 13 and the lower wall 14. The extended portions 70 are moved toward and away from the limiting surfaces 62a, 62b, 62c, 62d, 62e of the raised surfaces 60 accompanying rotation of the fins 31a, 31b, 31c, 31d, 31e.

As shown in FIG. 2, a portion of the right side wall 12 of the register body 10 located to the right of the rotation shaft 50 of the fin 31e is protruded toward the air passage 15, thereby forming a raised surface. The raised surface is oriented to the downstream side and extends in the vertical direction. The raised surface serves as a receiving surface 81, effects of which are to be described later.

A portion of the left side wall 11 of the register body 10 located to the left of the rotation shaft 50 of the fin 31a is protruded toward the air passage 15, thereby forming a raised surface. The raised surface is oriented to the upstream side and extends in the vertical direction. The raised surface serves as a receiving surface 85, effects of which are to be described later.

In the register device 1 having the features mentioned above, when the operation knob 40 is moved rightward from a state shown in FIG. 2, the fins 31a, 31b, 31c, 31d, 31e are tilted rightward, and the air from the air conditioner blows out rightward.

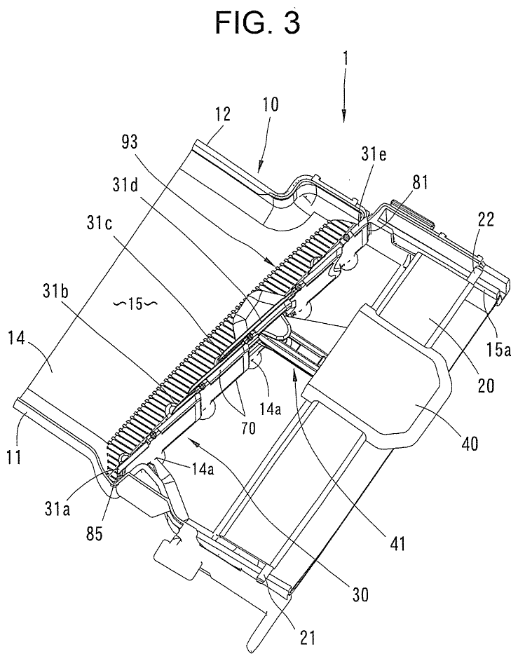

When the operation knob 40 is moved further rightward, as shown in FIG. 3, the fins 31a, 31b, 31c, 31d, 31e are contacted with one another overlapped with one another. At this time, the fin at the rightmost side 31e is abutted against the receiving surface 81 of the right side wall 12 and the fin at the leftmost side 31a is abutted against the receiving surface 85 of the left side wall 13. The extended portions 70 at the upper ends and the lower ends of the fins 31a, 31b, 31c, 31d, 31e are respectively abutted against the limiting surfaces 62a, 62b, 62c, 62d, 62e of the upper wall 13 and the lower wall 14. Thereby, the air passage 15 is closed off.

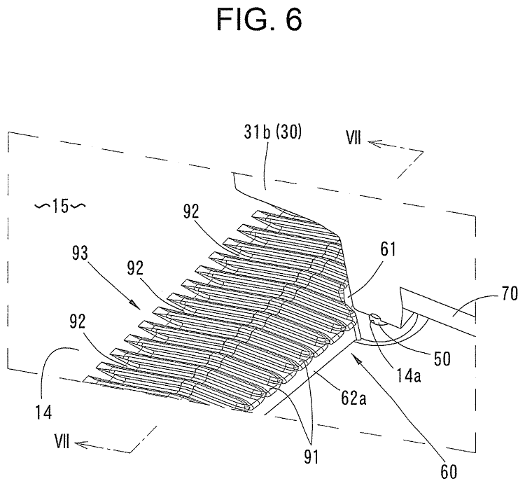

As shown in FIG. 6, the raised surface 60 in the lower wall 14 of the register body 10 of the register device 1 has saw-toothed notches 91 formed in an edge portion thereof on a side of the central axis of the air passage 15, thereby forming what is called serration. The notches 91 are formed generally across the lower wall 14 in the left-right direction.

The notches 91 extend toward the upstream side of the air passage 15. Lengthwise grooves 92 are formed in the lower wall 14 on the upstream side of the raised surface 60. Thereby, a riblet portion 93 that is a collection of minute row of ribs are formed in the lower wall 14.

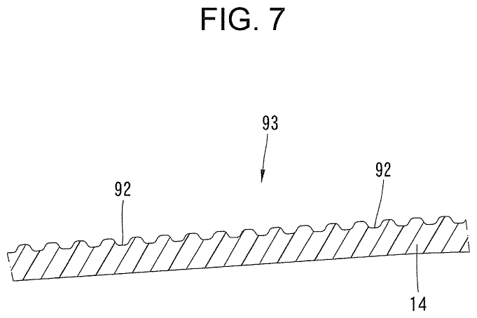

In this embodiment, the riblet portion 93 is formed in a raised portion of an inner surface of the lower wall 14. An end portion of the riblet portion 93 on the upstream side is gently integrated with a surface of a flat portion of the lower wall 14. As shown in FIG. 7, the riblet portion 93 has a gentle trapezoidal cross-sectional configuration. The notches 91 also have gentle trapezoidal configurations.

Although not shown in this embodiment, notches 91 are also formed in an edge portion of the raised surface 60 of the upper wall 13 in a similar manner to the lower wall 14. Lengthwise grooves 92 are formed on the upstream side of the notches 91, thereby forming a riblet portion 93.

In the register device 1 having the features mentioned above, vortexes of air passing through the edge portions of the raised surfaces 60 are fragmented by the saw-toothed notches 91 formed in the edge portions of the raised surfaces 60 of the upper wall 13 and the lower wall 14, thereby constraining separation of large vortexes. Thereby, rapid pressure variations are suppressed, and therefore, generation of abnormal noises can be reduced.

The riblet portions 93 on the upstream side of the raised surfaces 60 of the upper wall 13 and the lower wall 14 work to reduce areas of the upper wall 13 and the lower wall 14 hit by air flowing rapidly. Thereby, resistance of vortexes can be reduced and contact friction resistance can be reduced. Further, pressure loss can be reduced.

Further, since the riblet portion 93 has the gentle trapezoidal cross-sectional configuration, the contact friction resistance can be reduced even when the riblet portion 93 is angled from parallel with respect to a direction of the air flow.

The disclosure is not limited to the embodiment described above and various modifications may be adopted without departing from the spirit or scope of the disclosure.

The notches 91 and the lengthwise grooves 92 may be formed in only one of the upper wall 13 and the lower wall 14.

The notches 91 and the lengthwise grooves 92 may be formed in a protruded portion of the right side wall 12 having the receiving surface 81 and in a protruded portion of the left side wall 13 having the receiving surface 85.

The notches 91 may have a rectangular configuration, a triangular configuration or other configurations.

The row of ribs constituting the riblet portion 93 may be composed of ribs having plate-like configurations, triangular cross-sectional configurations, rectangular cross-sectional configuration or other configurations.

In a register device in which an air passage is closed off by a shutter (opening and closing plate portion) disposed on an upstream side of an upstream side fin assembly, saw-toothed notches may be formed in an edge portion of a raised surface against which the shutter is abutted when closing off the air passage. Lengthwise grooves extending from the notches may be formed in peripheral walls.

In the present embodiment, the register device 1 with the single blow outlet side fin 20 is described. A register device may include a plurality of fins and an interlocking link rotatably connecting the fins as a blow outlet side fin assembly.

The present disclosure may be applied to a register device for a vehicle including an opening and closing plate portion for opening and closing an air passage.

According to the disclosure, a register device for a vehicle in which generation of abnormal noises is constrained can be provided.

Although an example embodiment and modification examples of the disclosure are described hereinabove, the foregoing embodiment and modification examples are mere examples and are not intended to limit the scope of the disclosure. It should be also appreciated that various omissions, replacements, and modifications may be made in the foregoing embodiment and modification examples described herein, without departing from the scope of the disclosure. The disclosure is intended to include such modifications and alterations in so far as they fall within the scope of the appended claims or the equivalents thereof.

1. A register device for a vehicle comprising:
a register body including peripheral walls and an inner portion surrounded by the peripheral walls, the inner portion serving as an air passage;
an opening and closing plate portion rotatably disposed in the inner portion surrounded by the peripheral walls, the opening and closing plate portion opening and closing the air passage;
a raised surface formed in the peripheral walls, the raised surface abutted against an edge portion of the opening and closing plate portion when the opening and closing plate portion is in a closing state; and
saw-toothed notches formed in an edge portion of the raised surface on a side of a central axis of the air passage.

2. The register device for the vehicle according to claim 1, wherein lengthwise grooves are formed in an inner surface of the peripheral walls, the lengthwise grooves extending in an extending direction of the air passage from the notches of the edge portion of the raised surface.

3. The register device for the vehicle according to claim 2, wherein the lengthwise grooves have trapezoidal cross-sectional configurations.
